(19) United States
(12) Patent Application Publication
(10) Pub. No.: US 2013/0254055 A1
(43) Pub. Date: Sep. 26, 2013

(54) Commerce System and Method of Learning Consumer Behavior Based on Prior and Current Transactions

(71) Applicants: Prashant Warier, Maharashtra (IN); Omkar Pandit, Maharashtra (IN); Srikanth Velamakanni, Foster City, CA (US); Natwar Mall, Mumbai (IN)

(72) Inventors: Prashant Warier, Maharashtra (IN); Omkar Pandit, Maharashtra (IN); Srikanth Velamakanni, Foster City, CA (US); Natwar Mall, Mumbai (IN)

(73) Assignee: FRACTAL ANALYTICS, INC., Jersey City, NJ (US)

(21) Appl. No.: 13/426,541

(22) Filed: Mar. 21, 2012

(51) Int. Cl. G06Q 30/06

(52) U.S. Cl. 705/26.1

(57) ABSTRACT

A commerce system involves purchase transactions between retailers and consumers. The purchase transaction includes products associated by a common product type. A plurality of classifications is defined based on an attribute of the products within the common product type. Transaction probabilities for each classification are determined based on a prior transaction probability and transaction weight for each product. A consumer probability associated with each classification is revised based on a prior consumer probability and the transaction probabilities. The consumer probability indicates a likelihood of a consumer purchasing a product having the attribute associated with the classification. A product probability associated with each classification is revised based on a prior transaction probability, consumer probability, and product weight. The product probability indicates a likelihood of a product having the attribute associated with the classification. Transactions within the commerce system are controlled based on the consumer probability and product probability.

### FIELD OF THE INVENTION

The present invention relates in general to consumer purchasing and, more particularly, to a commerce system and method of learning consumer behavior based on prior and current transactions.

### BACKGROUND OF THE INVENTION

Consumers make purchasing decisions based on a variety of factors including price, quality, service, necessity, convenience, and fashion. Retailers regularly update and revise business plans to understand and adapt to shifting consumer behavior and patterns. For example, if consumers exhibit a new preference for a particular product or type of product, retailers need to recognize that trend and modify the marketing approach accordingly. The consumer behavior and pattern can be seasonal, regional, demographic, and temporal in origin and trend. Consumer behavior is integral to the purchasing decision.

Retailers have used a variety of marketing models to understand shifting consumer behavior and patterns. For example, traditional recency of purchase, frequency of purchase, and monetary value of purchase (RFM) segmentation has been used to target specific consumer groups. RFM segmentation relies on the general notion that consumers who purchased recently are likely to respond better to promotions, and they are also more likely to purchase again, compared to someone who has not purchased for a long time. Frequent buyers are more likely to buy again than infrequent buyers. Consumers who make larger purchases are more responsive to marketing than low spenders. Retailers also look to demographic data to understand consumer behavior and patterns.

Grocery stores, general merchandise stores, specialty shops, and other retail outlets face stiff competition for limited consumers and business. Most, if not all, retail stores use every available resource, including modeling, and expend great effort to maximize sales, revenue, and profit. Successful retailers understand the need to evaluate, learn, and follow consumer behavior in order to maximize sales, revenue, and profit.

### SUMMARY OF THE INVENTION

A need exists to understand consumer behavior and patterns in order to optimize commercial transactions. Accordingly, in one embodiment, the present invention is a method of controlling a commerce system comprising the steps of receiving a purchase transaction including products associated by a common product type from a member of the commerce system, defining a plurality of classifications based on an attribute of the products within the common product type, determining a plurality of transaction probabilities for each classification based on a prior transaction probability and transaction weight for each product, revising a consumer probability associated with each classification based on a prior consumer probability and the transaction probabilities, revising a product probability associated with each classification based on a prior transaction probability, consumer probability, and product weight, and controlling transactions within the commerce system based on the consumer probability and product probability.

In another embodiment, the present invention is a method of controlling a commerce system comprising the steps of providing a purchase transaction including products with a transaction weight, defining a plurality of classifications based on an attribute of the products, determining a plurality of transaction probabilities for each classification based on a prior transaction probability and transaction weight for each product, revising a consumer probability associated with each classification based on a prior consumer probability and the transaction probabilities, and controlling transactions within the commerce system based on the consumer probability.

In another embodiment, the present invention is a method of controlling a commerce system comprising the steps of providing a purchase transaction including products with a transaction weight, defining a plurality of classifications based on an attribute of the products, determining a plurality of transaction probabilities for each classification based on a prior transaction probability and transaction weight for each product, revising a product probability associated with each classification based on a prior transaction probability and consumer probability, and controlling transactions within the commerce system based on the product probability.

In another embodiment, the present invention is a computer program product usable with a programmable computer processor having a computer readable program code embodied in a computer usable medium for controlling a commerce system comprising the steps of providing a purchase transaction including products with a transaction weight, defining a plurality of classifications based on an attribute of the products, determining a plurality of transaction probabilities for each classification based on a prior transaction probability and transaction weight for each product, revising a consumer probability associated with each classification based on a prior consumer probability and the transaction probabilities, and controlling transactions within the commerce system based on the consumer probability.

### BRIEF DESCRIPTION OF THE DRAWINGS

FIG. 1 illustrates a commerce system which analyzes T-LOG data to update a marketing plan and execute on a business plan;

FIG. 2 illustrates a commercial supply, distribution, and consumption chain;

FIG. 3 illustrates commercial transactions between consumers and retailers with the aid of a service provider;

FIG. 4 illustrates the service provider using T-LOG data to evaluate consumer transactions, revise a knowledge base, and report on consumer behavior toward products;

FIG. 5 illustrates a computer system operating with an electronic communication network;

FIG. 6 illustrates a product seed matrix with seed classifications, seed probabilities, and seed weights;

FIG. 7 illustrates a consumer transaction with prior transaction probabilities;

FIG. 8 illustrates a consumer probability table to determine revised consumer classification probabilities according to FIG. 7;

FIGS. 9a-9d illustrate product probability tables to determine revised product classification probabilities according to FIGS. 7 and 8;

FIG. 10 illustrates another consumer transaction with prior transaction probabilities;

FIG. 11 illustrates a consumer probability table to determine revised consumer classification probabilities according to FIG. 10;

FIGS. 12a-12b illustrate product probability tables to determine revised product classification probabilities according to FIGS. 10 and 11;

FIG. 13 illustrates another consumer transaction with prior transaction probabilities;

FIG. 14 illustrates a consumer probability table to determine revised consumer classification probabilities according to FIG. 13;

FIGS. 15a-15d illustrate product probability tables to determine revised product classification probabilities according to FIGS. 13 and 14;

FIG. 16 illustrates segmentation of consumer behavior based on T-LOG data; and

FIG. 17 illustrates a process of controlling a commerce system by evaluating consumer probabilities and product probabilities to understand consumer behavior.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

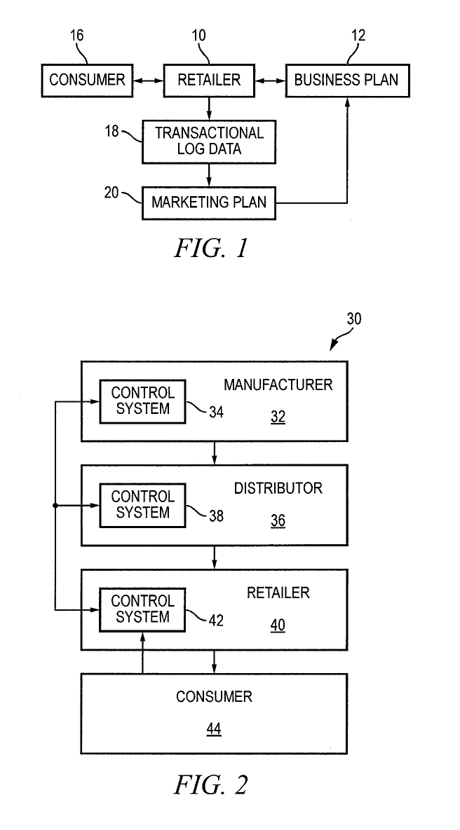

Referring to FIG. 1, retailer 10 has certain product lines or services available to consumers as part of its business plan 12. The terms “products” and “services” are interchangeable in the commercial system. Retailer 10 can be a food store chain, general consumer product retailer, drug store, discount warehouse, department store, apparel store, specialty store, or service provider. Retailer 10 has the ability to set pricing, order inventory, run promotions, arrange its product displays, collect and maintain historical sales data, and adjust its strategic business plan.

Business plan 12 gives retailer 10 the ability to evaluate performance and trends, make strategic decisions, set pricing, order inventory, hire employees, expand stores, add and remove product lines, organize product shelving and displays, select signage, and the like. Business plan 12 allows retailer 10 to analyze data, evaluate alternatives, and make decisions to control its operations.

Retailer 10 routinely enters into sales transactions with customer or consumer 16. In fact, retailer 10 maintains and updates its business plan 12 to increase the number of transactions (and thus revenue and/or profit) between retailer 10 and consumer 16. Consumer 16 can be a specific individual, account, or business entity. For each sale transaction entered into between retailer 10 and consumer 16, information describing the transaction is stored in T-LOG 18. When a consumer goes through the check-out at a grocery or any other retail store, each of the items to be purchased is scanned and data is collected and stored by a point-of-sale (POS) system, or other suitable data storage system, in T-LOG 18. The data includes the then current price, promotion, and merchandizing information associated with the product along with the units purchased, and the dollar sales. The date and time, and store and consumer information corresponding to that purchase are also recorded.

Retailer 10 also prepares and executes on marketing plan 20 to evaluate consumer behavior and patterns and run promotions directed toward those behaviors in order to increase sales. T-LOG data 18 can be used to revise marketing plan 20, as described below. Marketing plan 20 influences business plan 12. Retailer 10 can change business plan 12 and marketing plan 20 as needed.

T-LOG 18 contains one or more line items for each retail transaction, such as those shown in Table 1. Each line item includes information or attributes relating to the transaction, such as store number, product number, product category or type of product, time of transaction, transaction number, quantity, current price, promotion number, and consumer category or type number. The store number identifies a specific store; product number identifies a product; product category identifies a type of product; time of transaction includes date and time of day; quantity is the number of units of the product; current price (in US dollars) can be the regular price, reduced price, or higher price in some circumstances; promotion number identifies any promotion associated with the product, e.g., flyer, ad, sale price, coupon, rebate, end-cap, etc.; consumer identifies the consumer by type, class, region, or individual, e.g., discount card holder, government sponsored or under-privileged, volume purchaser, corporate entity, preferred consumer, or special member. T-LOG 18 is accurate, observable, and granular product information based on actual retail transactions within the store. T-LOG 18 represents the known and observable results from the consumer buying decision or process. T-LOG 18 may contain thousands of transactions for retailer 10 per store per day, or millions of transactions per chain of stores per day.

TABLE 1
T-LOG Data

| STORE | PRODUCT | TYPE | TIME | TRANS | QTY | PRICE | PROMOTION | CONSUMER |
|---|---|---|---|---|---|---|---|---|
| S1 | P1 | PT1 | D1 | T1 | 1 | 15.50 | PROMO1 | C1 |
| S1 | P2 | PT1 | D1 | T1 | 2 | 7.85 | PROMO2 | C1 |
| S1 | P3 | PT1 | D1 | T1 | 1 | 94.20 | PROMO3 | C1 |
| S1 | P4 | PT2 | D1 | T2 | 2 | 4.75 | 0 | C1 |
| S1 | P5 | PT3 | D1 | T3 | 1 | 43.95 | 0 | C1 |
| S1 | P6 | PT4 | D2 | T4 | 4 | 5.40 | PROMO4 | C2 |
| S1 | P7 | PT4 | D2 | T4 | 3 | 1.50 | 0 | C2 |
| S2 | P4 | PT2 | D3 | T5 | 1 | 4.25 | PROMO5 | C2 |
| S2 | P8 | PT3 | D3 | T6 | 2 | 57.50 | PROMO6 | C3 |
| S2 | P9 | PT3 | D3 | T6 | 1 | 76.30 | 0 | C3 |

The first line item shows that on day/time D1, store S1 has transaction T1 in which consumer C1 purchases one product P1 at $15.50 with PROMO1, two products P2 at $7.85 each with PROMO2, and one product P3 at price $94.20 with PROMO3. Products P1, P2, and P3 have product type PT1, e.g., home tools. In transaction T2 on day/time D1, consumer C1 purchases two products P4 at price $4.75 each without promotion. Product P4 has product type PT2, e.g., breakfast cereal. In transaction T3 on day/time D1, consumer C1 purchases one product P5 at price $43.95 without promotion. Product P5 has product type PT3, e.g., women's shoes. In transaction T4 on day/time D2, consumer C2 purchases four products P6 at price $5.40 each and one product P7 at price $1.50. Products P6 and P7 have product type PT4, e.g., infant-related items. In transaction T5 on day/time D3, consumer C2 patronizes store S2 and purchases one product P4 at price $4.25 with PROMO5. Product P4 has product type PT2, e.g., breakfast cereal. In transaction T6 on day/time D3, consumer C3 patronizes store S2 and purchases two products P8 at price $57.50 each with PROMO6 and one product P9 at price $76.30. Products P8 and P9 have product type PT3, e.g., women's shoes. PROMO1-PROMO6 can be any suitable product promotion such as a front-page featured item in a local advertising flyer, end-cap display, volume discount, temporary reduced price, or rebate.

Retailer 10 may also provide additional information to T-LOG 18 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG 18.

In FIG. 2, a commerce system 30 is shown involving the movement of goods between members of the system. Manufacturer 32 produces goods in commerce system 30. Manufacturer 32 uses control system 34 to receive orders, control manufacturing and inventory, and schedule deliveries. Distributor 36 receives goods from manufacturer 32 for distribution within commerce system 30. Distributor 36 uses control system 38 to receive orders, control inventory, and schedule deliveries. Retailer 40 receives goods from distributor 36 for sale within commerce system 30. Retailer 40 uses control system 42 to place orders, control inventory, and schedule deliveries with distributor 26. Retailer 40 sells goods to consumer 44. Consumer 44 patronizes retailer's establishment either in person or using online ordering. The consumer purchases are entered into control system 42 of retailer 40 as T-LOG data 18.

Marketing plan 20 utilized by retailer 40 influences the purchasing decisions made by consumer 44. A more effective marketing plan 20 increases the sales of goods, which drives the manufacturing, distribution, and retail portions of commerce system 30. More purchasing decisions made by consumer 44 for retailer 40 leads to more merchandise movement for all members of commerce system 30. Manufacturer 32, distributor 36, and retailer 40 respond to the sales volume to control and optimize the ordering, manufacturing, distribution, sale of the goods, and otherwise execute respectively the business plans within commerce system 30 in accordance with the purchasing decisions made by consumer 44.

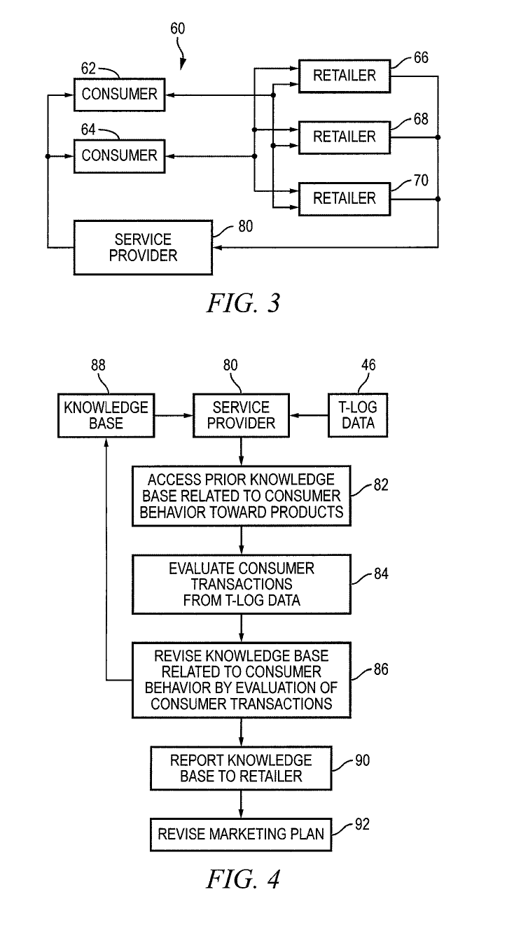

FIG. 3 illustrates a commerce system 60 with consumers 62 and 64 engaged in purchasing transactions with retailers 66, 68, and 70. Retailers 66-70 are supplied by manufacturers and distributors, as described in FIG. 2. Retailers 66-70 are typically local to consumers 62-64, i.e., retailers that the consumers will likely patronize. Retailers 66-70 can also be remote from consumers 62-64 with transaction handled by electronic communication medium, e.g., phone or online website via personal computer, and delivered electronically or by common carrier, depending on the nature of the goods. Consumers 62-64 patronize retailers 66-70 either in person in the retailer's store or by electronic communication medium to select one or more items for purchase from one or more retailers. For example, consumer 62 can visit the store of retailer 66 in person and select product P1 for purchase. Consumer 62 can contact retailer 68 by phone or email and select product P2 for purchase. Consumer 64 can browse the website of retailer 70 using a personal computer and select product P3 for purchase. Accordingly, consumers 62-64 and retailers 66-70 regularly engage in regular commercial transactions within commerce system 60.

In FIG. 3, service provider 80 is a part of commerce system 60. Service provider 80 is a third party that assists retailers 66-70 (or manufactures 32 or distributors 36) with collecting, evaluating, revising, and reporting on a knowledge base of consumer behavior and patterns related to specific products or types of products. Service provider 80 works with the members of commerce system 60 to control commercial transactions within the commerce system by maintaining the knowledge base of consumer behavior and patterns related to specific products or types of products. The knowledge base learns from prior and present consumer transactions and allows retailers 66-70 to make inferences about consumer behavior and patterns related to specific products or types of products.

More specifically, service provider 80 receives T-LOG data 18 from one or more of retailers 66-70 (or manufactures 32 or distributors 36), as shown in FIG. 4. In block 82, service provider 80 accesses prior knowledge base related to consumer behavior toward a product or product type. The knowledge base contains information such as product, product type, seed classification, probability of seed classifications, seed weight, current product classification, probability of current product classification, and probability of consumer specific classifications. In block 84, service provider 80 evaluates consumer transactions for the product or product type from T-LOG data 18. In block 86, service provider 80 revises the knowledge base related to consumer behavior toward the product or product type from the evaluation of the consumer transaction. The cycle between blocks 82-86 repeats for each consumer transaction to continuously revise knowledge base 88 based on prior and current consumer transactions. In block 90, the knowledge base related to consumer behavior toward the product or product type is reported back to retailers 66-70 from time-to-time or upon request through an electronic communication link. In block 92, retailers 66-70 use knowledge base 88 to analyze consumer behavior toward the product or product type and revise marketing plan 20 and business plan 12. Knowledge base 88 identifies individual segments of consumer behavior. Retailers 66-70 can use the consumer segmentation from knowledge base 88 to run promotions directed to target consumer groups or specific consumers.

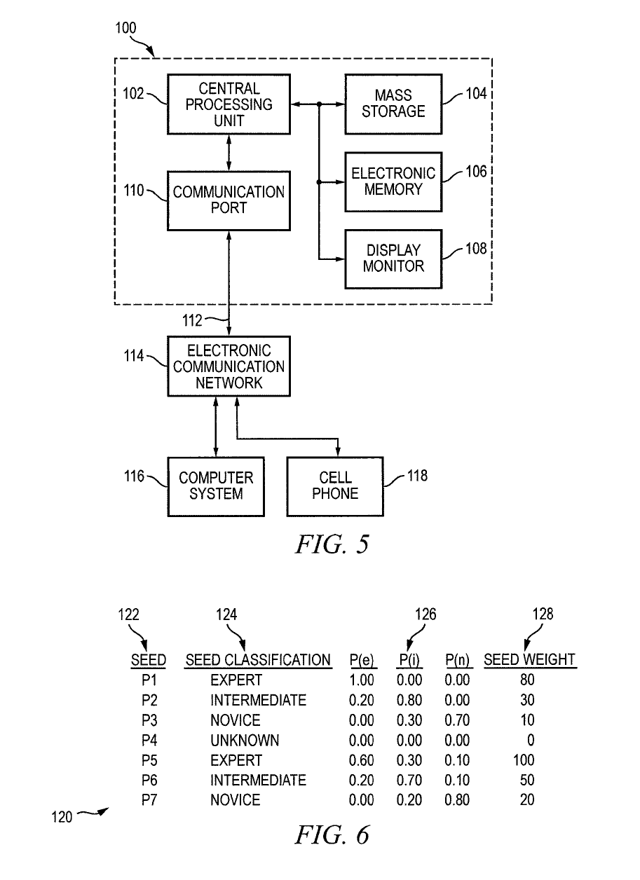

Service provider 80 and retailers 66-70 use an electronic communication network to transmit and receive data. FIG. 5 illustrates a simplified computer system 100 for executing the software program used in the electronic communication process. Computer system 100 is a general purpose computer including a central processing unit or microprocessor 102, mass storage device or hard disk 104, electronic memory 106, display monitor 108, and communication port 110. Communication port 110 represents a modem, high-speed ethernet link, wireless, or other electronic connection to transmit and receive input/output (I/O) data over communication link 112 to electronic communication network 114. The electronic communication network 114 is a distributed network of interconnected routers, gateways, switches, and servers, each with a unique internet protocol (IP) address to enable communication between individual computers, cellular telephones, electronic devices, or nodes within the network. Computer system or server 116 can be configured as shown for computer 100. Computer system 116 and cellular telephone 118 transmit and receive information and data over communication network 114.

Computer systems 100 and 116 can be physically located in any location with access to a modem or communication link to network 114. For example, service provider 80 and retailers 66-70 can use computer system 100 or 116 in its business office. Alternatively, computer 100 or 116 can be mobile and follow the user to any convenient location, e.g., remote offices, consumer locations, hotel rooms, residences, vehicles, public places, or other locales with electronic access to electronic communication network 114.

Each of the computers run application software and computer programs, which can be used to display user interface screens, execute the functionality, and provide the electronic communication features as described below. The application software includes an Internet browser, local email application, word processor, spreadsheet, and the like. In one embodiment, the screens and functionality come from the application software, i.e., the electronic communication runs directly on computer system 110 or 116. Alternatively, the screens and functions are provided remotely from one or more websites on servers within electronic communication network 114.

The software is originally provided on computer readable media, such as compact disks (CDs), external drive, or other mass storage medium. Alternatively, the software is downloaded from electronic links, such as the host or vendor website. The software is installed onto the computer system hard drive 104 and/or electronic memory 106, and is accessed and controlled by the computer's operating system. Software updates are also electronically available on mass storage medium or downloadable from the host or vendor website. The software, as provided on the computer readable media or downloaded from electronic links, represents a computer program product containing computer readable program code embodied in a computer program medium. Computers 100 and 116 run application software for executing instructions for communication between retailers 66-70 and service provider 80, gathering product information, evaluate consumer transactions, and revising marketing plan 20 to respond to shifting consumer behavior and patterns. The application software is an integral part of the control of business transactions within commerce system 60.

Returning to FIG. 4, service provider 80 maintains knowledge base 88 containing prior information about consumer transactions. In one embodiment, knowledge base 88 is implemented as a computer database. Knowledge base 88 contains consumer related information and product related information, each based on previous and current consumer transactions. The consumer related information includes consumer classification probabilities, consumer weighting, and consumer identification. The product related information includes product classification probabilities, product weighting, and product identification. If no historical transactions are available, knowledge base 88 uses a product seed matrix 120, as shown in FIG. 6. Seed matrix 120 contains seed product in column 122, seed classification in column 124, probability of each seed classification in column 126, and seed weight in column 128, for products P1-P7 of a given product type. The seed classifications are consumer behavior attributes associated with a given product type.

In one example, seed matrix 120 is set up for product type PT1 as home tools. For the given product type of home tools, product P1 has a seed classification of “expert”, i.e., substantial knowledge and experience is recommended for consumer use. An expert classification could be assigned to a rotary saw, electrical tester, or nail gun. The consumer is advised that substantial training and guidance is recommended for the use of expert home tools. Otherwise, serious personal injury or property damage may result. Product P2 has a seed classification of “intermediate”, i.e., some basic knowledge and experience is recommended for consumer use. An intermediate classification could be assigned to a razor cutter, chemical strippers, or gas barbeque grills. The consumer is advised that some basic understanding of the use of intermediate home tools is recommended. Product P3 has a seed classification of “novice”, i.e., no prior training or experience is needed for consumer use. A novice classification could be assigned to a screw driver, paint brush, picture hanger, or outside patio chair. The consumer is advised that the novice home tool should be safe to use without any prior training or experience. Product P4 has no seed classification and is unknown. Product P5 has an expert seed classification, product P6 has an intermediate seed classification, and product P7 has a novice seed classification, as described above.

Knowledge base 88 also contains probabilities for each classification of products P1-P7. Product P1 has a probability of an expert seed classification of P(e)=1.00, probability of an intermediate seed classification of P(i)=0.00, and probability of a novice seed classification of P(n)=0.00. Product P1 has a seed weight of 80. The seed weight is a weighting factor correlated to the given seed classifications. The greater the seed weight, the greater the weighting factor or impact of the seed classification probabilities on the evaluation of the product transaction and revision of consumer classification probabilities and product classification probabilities to knowledge base 88. In one embodiment, the seed weight is the monetary value of the product, i.e., purchase price. Accordingly, product P1 has the highest likelihood of being an expert classification of a home tool, with the given seed probabilities and seed weight. Product P2 has a probability of an expert seed classification of P(e)=0.20, probability of an intermediate seed classification of P(i)=0.80, and probability of a novice seed classification of P(n)=0.00. Product P2 has a seed weight of 30. Accordingly, product P2 may be either an expert classification of home tool or intermediate classification of home tool, with the given seed probabilities and seed weight. Product P3 has a probability of an expert seed classification of P(e)=0.00, probability of an intermediate seed classification of P(i)=0.30, and probability of a novice seed classification of P(n)=0.70. Product P3 has a seed weight of 10. Accordingly, product P3 may be either an intermediate classification of home tool or novice classification of home tool, with the given seed probabilities and seed weight. Product P4 has a probability of an expert seed classification of P(e)=0.00, probability of an intermediate seed classification of P(i)=0.00, and probability of a novice seed classification of P(n)=0.00. Product P4 has a seed weight of 0. Accordingly, product P4 has no certainty or confidence of being any particular classification of home tool. The seed classifications of product P4 are unknown.

Product P5 has a probability of an expert seed classification of P(e)=0.60, probability of an intermediate seed classification of P(i)=0.30, and probability of a novice seed classification of P(n)=0.10. Product P5 has a seed weight of 100. Accordingly, product P5 may be an expert classification of home tool, intermediate classification of home tool, or novice classification of home tool, with the given seed probabilities and seed weight. Product P6 has a probability of an expert seed classification of P(e)=0.20, probability of an intermediate seed classification of P(i)=0.70, and probability of a novice seed classification of P(n)=0.10. Product P6 has a seed weight of 50. Accordingly, product P6 may be either an expert classification of home tool, intermediate classification of home tool, or novice classification of home tool, with the given seed probabilities and seed weight. Product P7 has a probability of an expert seed classification of P(e)=0.00, probability of an intermediate seed classification of P(i)=0.20, probability of a novice seed classification of P(n)=0.80. Product P7 has a seed weight of 20. Accordingly, product P7 has a moderate to high certainty of being either an intermediate classification of home tool or novice classification of home tool, with the given seed probabilities and seed weight.

Service provider 80 evaluates prior transactions and current consumer transactions, and revises knowledge base 88 based on the transaction evaluation. FIG. 7 shows a consumer transaction T1 from T-LOG data 18. Consumer 62 purchases products P1-P4 as shown in transaction matrix 130. The purchase price of product P1 is $83, purchase price of product P2 is $25, purchase price of product P3 is $14, and purchase price of product P4 is $40. The prior product probabilities P(e)_{P}, P(i)_{P}, and P(n)_{P} for products P1-P4 from seed matrix 120 are inserted into transaction matrix 130.

The transaction evaluation uses the prior product probabilities P(e)_{P}, P(i)_{P}, and P(n)_{P} and transaction prices for products P1-P4 to determine weighted transaction probabilities for each product classification. The transaction probability of expert classification P(e)_{T} for products P1-P4 in transaction T1 is given in equation (1):

P(e)_{T}=[(P(e)_{P1}*transaction price_{P1})+(P(e)_{P2}*transaction price_{P2})+(P(e)_{P3}*transaction price_{P3})+(P(e)_{P4}*transaction price_{P4})]/transaction weight (1)

where:
P(e)_{P1} is the probability of expert classification for product P1
P(e)_{P2} is the probability of expert classification for product P2
P(e)_{P3} is the probability of expert classification for product P3
P(e)_{P4} is the probability of expert classification for product P4
transaction price_{P1} is the transaction price for product P1
transaction price_{P2} is the transaction price for product P2
transaction price_{P3} is the transaction price for product P3
transaction price_{P4} is the transaction price for product P4
transaction weight is transaction price_{P1}+transaction price_{P2}+transaction price_{P3}+transaction price_{P4}

From the values in transaction matrix 130, transaction probability for expert classification P(e)_{T} in transaction T1 is [1.00*83+0.20*25+0.00*14+0.00*40]/[83+25+14+40]=0.54. The transaction weight for transaction T1 is 83+25+14+40=162.

The transaction probability of intermediate classification P(i)_{T} for products P1-P4 in transaction T1 is given in equation (2):

P(i)_{T}=[(P(i)_{P1}*transaction price_{P1})+(P(i)_{P2}*transaction price_{P2})+(P(i)_{P3}*transaction price_{P3})+(P(i)_{P4}*transaction price_{P4})]/transaction weight (2)

where:
P(i)_{P1} is the probability of intermediate classification for product P1
P(i)_{P2} is the probability of intermediate classification for product P2
P(i)_{P3} is the probability of intermediate classification for product P3
P(i)_{P4} is the probability of intermediate classification for product P4

From the values in transaction matrix 130, transaction probability P(i)_{T} in transaction T1 is [0.00*83+0.80*25+0.30*14+0.00*40]/[83+25+14+40]=0.15.

The transaction probability of novice classification P(n)_{T} for products P1-P4 in transaction T1 is given in equation (3):

P(n)_{T}=[(P(n)_{P1}*transaction price_{P1})+(P(n)_{P2}*transaction price_{P2})+(P(n)_{P3}*transaction price_{P3})+(P(n)_{P4}*transaction price_{P4})]/transaction weight (3)

where:
P(n)_{P1} is the probability of novice classification for product P1
P(n)_{P2} is the probability of novice classification for product P2
P(n)_{P3} is the probability of novice classification for product P3
P(n)_{P4} is the probability of novice classification for product P4

From the values in transaction matrix 130, transaction probability P(n)_{T} in transaction T1 is [0.00*83+0.00*25+0.70*14+0.00*40]/[83+25+14+40]=0.06.

The transaction probabilities P(e)_{T}=0.54, P(i)_{T}=0.15, and P(n)_{T}=0.06 take into account prior product classification probabilities and current transaction price for each product in the transaction. Each product in transaction T1 from consumer 62 influences the transaction probabilities for each classification P(e)_{T}, P(i)_{T}, and P(n)_{T}.

The prior consumer classification probabilities, transaction classification probabilities P(e)_{T}, P(i)_{T}, and P(n)_{T} from transaction T1, and consumer weights specific to consumer 62 are used to update or revise consumer classification probabilities P(e)_{C}, P(i)_{C}, P(n)_{C}. If transaction T1 is the first transaction for consumer 62, i.e., no prior transactions, then prior consumer classification probabilities P(e)_{C}=0.00, P(i)_{C}=0.00, P(n)_{C}=0.00, and prior consumer weight is 0. Each transaction by consumer 62 updates or revises the consumer classification probabilities P(e)_{C}, P(i)_{C}, P(n)_{C} and consumer weight. Assume consumer 62 has conducted prior transactions and accumulated prior consumer classification probabilities P(e)_{C}=0.85, P(i)_{C}=0.38, P(n)_{C}=0.11, and prior consumer weight of 1000, as shown in consumer probability table 132 of FIG. 8. Given transaction classification probabilities P(e)_{T}=0.54, P(i)_{T}=0.15, and P(n)_{T}=0.06 and transaction prices for transaction T1, the revised consumer classification probabilities P(e)_{C}, P(i)_{C}, P(n)_{C}, and revised consumer weight for consumer 62 are determined in equations (4)-(6) as:

Revised P(e)_{C}=[(prior P(e)_{C}*prior consumer weight)+(P(e)_{T}*transaction weight)]/[prior consumer weight+transaction weight] (4)

Revised P(i)_{C}=[(prior P(i)_{C}*prior consumer weight)+(P(i)_{T}*transaction weight)]/[prior consumer weight+transaction weight] (5)

Revised P(n)_{C}=[(prior P(n)_{C}*prior consumer weight)+(P(n)_{T}*transaction weight)]/[prior consumer weight+transaction weight] (6)

where:
P(e)_{C} is the probability of consumer expert classification
(i)_{C} is the probability of consumer intermediate classification
P(n)_{C} is the probability of consumer novice classification

From the prior consumer classification probabilities, transaction probabilities P(e)_{T}, P(i)_{T}, and P(n)_{T}, transaction weights, and consumer weights, the revised P(e)_{C} for consumer 62 based on transaction T1 is [0.85*1000+0.54*162]/[1000+162]=0.81. The revised P(i)_{C} for consumer 62 based on transaction T1 is [0.38*1000+0.15*162]/[1000+162]=0.35. The revised P(n)_{C} for consumer 62 based on transaction T1 is [0.11*1000+0.06*162]/[1000+162]=0.10. The revised consumer weight for consumer 62 is the prior consumer weight+transaction weight, i.e., 1000+162=1162. The revised consumer classification probabilities P(e)_{C}, P(i)_{C}, P(n)_{C}, and revised consumer weight specific to consumer 62 are stored in knowledge base 88 for the next transaction with consumer 62 and products P1-P4, as well as being reported to retailers 66-70 upon request.

The revised consumer classification probabilities P(e)_{C}, P(i)_{C}, P(n)_{C}, are indicative of the purchasing behavior or pattern of consumer 62 in that he or she is more likely (0.81) to purchase expert classification home tools. Consumer 62 has a lower probability (0.35) of purchasing intermediate classification home tools, as compared to expert classification home tools. Consumer 62 has a lower probability (0.10) of purchasing novice classification home tools, as compared to intermediate classification home tools. The revised consumer weight provides an indication of the total purchasing behavior of consumer 62.

The prior product classification probabilities, prior product weights, consumer classification probabilities P(e)_{C}, P(i)_{C}, and P(n)_{C}, and transaction weights from transaction T1 are used to update or revise product classification probabilities P(e)_{P}, P(i)_{P}, P(n)_{P}, and product weight for each product P1-P4. Given consumer classification probabilities P(e)_{C}=0.81, P(i)_{C}=0.35, and P(n)_{C}=0.10 and transaction prices for transaction T1, the revised consumer classification probabilities P(e)_{P}, P(i)_{P}, P(n)_{P}, and revised product weights for products P1-P4 is determined in equations (7)-(9) as:

Revised P(e)_{P}=[(prior P(e)_{P}*prior product weight)+(P(e)_{C}*transaction weight)]/[prior product weight+transaction weight] (7)

Revised P(i)_{P}=[(prior P(i)_{P}*prior product weight)+(P(i)_{C}*transaction weight)]/[prior product weight+transaction weight] (8)

Revised P(n)_{P}=[(prior P(n)_{P}*prior product weight)+(P(n)_{C}*transaction weight)]/[prior product weight+transaction weight] (9)

where:
P(e)_{P} is the probability of product expert classification
P(i)_{P} is the probability of product intermediate classification
P(n)_{P} is the probability of product novice classification

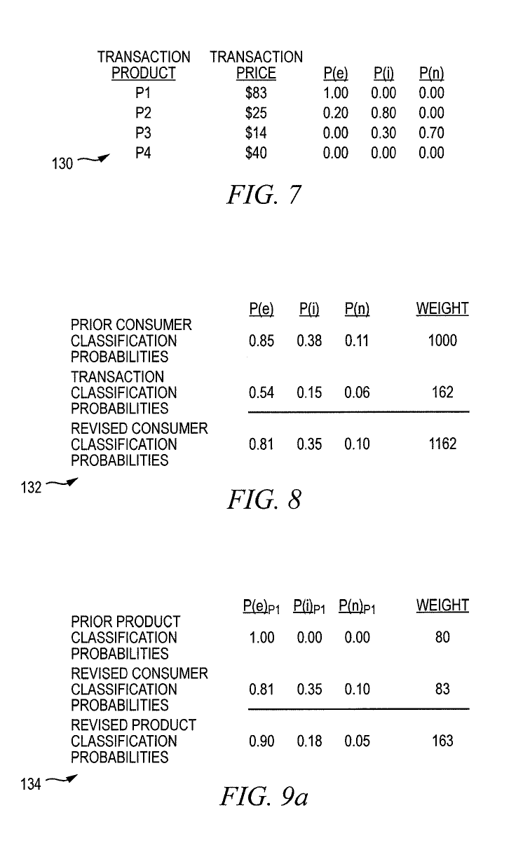

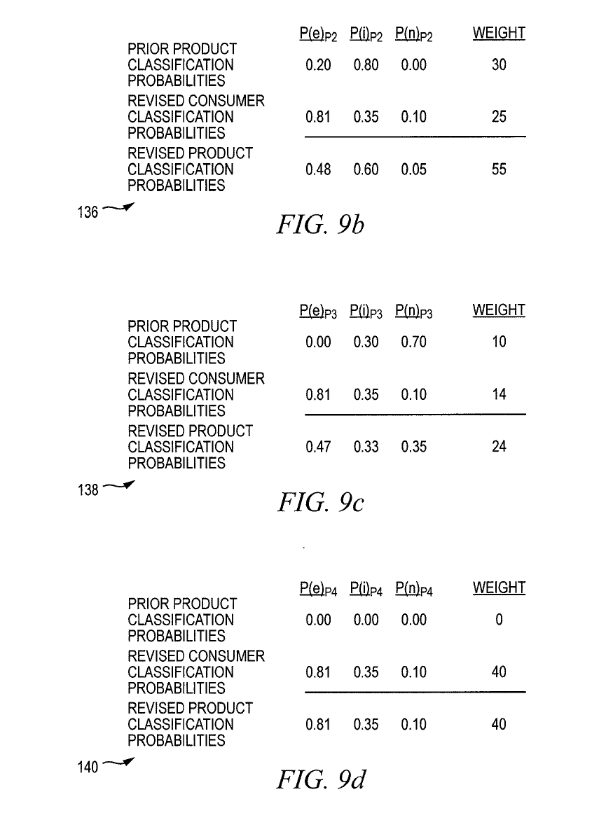

From the values in prior product classification probabilities P(e)_{P}, P(i)_{P}, and P(n)_{P}, and revised consumer classification probabilities P(e)_{C}, P(i)_{C}, and P(n)_{C}, the revised P(e)_{P1} for product P1 based on transaction T1 is [1.00*80+0.81*83]/[80+83]=0.90, as shown in product classification table 134 of FIG. 9a. The revised P(i)_{P1} for product P1 based on transaction T1 is [0.00*80+0.35*83]/[80+83]=0.18. The revised P(n)_{P1} for product P1 based on transaction T1 is [0.00*80+0.10*83]/[80+83]=0.05. The revised product weight for product P1 is the prior product weight+transaction weight, i.e., 80+83=163.

The revised P(e)_{P2} for product P2 based on transaction T1 is [0.20*30+0.81*25]/[30+25]=0.48, as shown in product classification table 136 of FIG. 9b. The revised P(i)_{P2} for product P2 based on transaction T1 is [0.80*30+0.35*25]/[30+25]=0.60. The revised P(n)_{P2} for product P2 based on transaction T1 is [0.00*30+0.10*25]/[30+25]=0.05. The revised product weight for product P2 is the prior product weight+transaction weight, i.e., 30+25=55.

The revised P(e)_{P3} for product P3 based on transaction T1 is [0.00*10+0.81*14]/[10+14]=0.47, as shown in product classification table 138 of FIG. 9c. The revised P(i)_{P3} for product P3 based on transaction T1 is [0.30*10+0.35*14]/[10+14]=0.33. The revised P(n)_{P3} for product P3 based on transaction T1 is [0.70*10+0.10*14]/[10+14]=0.35. The revised product weight for product P3 is the prior product weight+transaction weight, i.e., 10+14=24.

The revised P(e)_{P4} for product P4 based on transaction T1 is [0.00*0+0.81*40]/[0+40]=0.81, as shown in product classification table 140 of FIG. 9d. The revised P(i)_{P4} for product P4 based on transaction T1 is [0.00*0+0.35*40]/[0+40]=0.35. The revised P(n)_{P4} for product P4 based on transaction T1 is [0.00*0+0.10*40]/[0+40]=0.10. The revised product weight for product P1 is the prior product weight+transaction weight, i.e., 0+40=40.

The revised product classification probabilities P(e)_{P}, P(i)_{P}, P(n)_{P}, and revised product weight for each product P1-P4 are stored in knowledge base 88 for the next transaction. The revised product classification probabilities P(e)_{P}, P(i)_{P}, P(n)_{P}, are indicative of the proper product classification for products P1-P4 based on the consumer transactions.

The above process is repeated a sufficient number of times for each consumer with the same values from product seed matrix 120 and initial transactions from T-LOG data 18 to achieve stable product classification probabilities and consumer classification probabilities, i.e., until the change of product classification probability and consumer classification probability between successive iterations is insignificant. The product seed weights and consumer seed weights can be adjusted according to the level of learning to be carried from one iteration to the next.

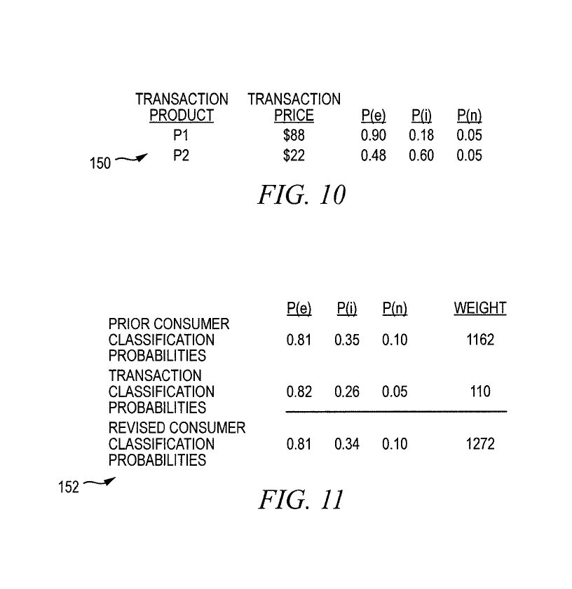

Once the product classification probabilities and consumer classification probabilities have reached steady-state, knowledge base 88 is continuously revised with new transactions using the learning process described above. For example, consumer 62 conducts transaction T2 to purchase products P1 and P2, as shown in FIG. 10. Service provider 80 evaluates consumer transaction T2 and revises knowledge base 88 based on the transaction evaluation. In transaction T2, consumer 62 purchases product P1 for $88 and product P2 for $22. The revised product probabilities P(e)_{P}, P(i)_{P}, and P(n)_{P} for products P1-P2, as revised from transaction T1, are taken from knowledge base 88 and inserted into transaction matrix 150.

The transaction evaluation uses the revised product probabilities P(e)_{P}, P(i)_{P}, and P(n)_{P} after transaction T1 and transaction prices for products P1-P2 in transaction T2 to determine weighted transaction probabilities for each product classification, see equation (1) but limited to products P1-P2. Note that the product classification probabilities P(e)_{P1}, P(i)_{P1}, P(n)_{P1}, P(e)_{P2}, P(i)_{P2}, and P(n)_{P2} from FIGS. 9a-9b are used for the prior product classification probabilities P(e)_{P}, P(i)_{P}, and P(n)_{P} in transaction T2. From the values in transaction matrix 150, transaction probability for expert classification P(e)_{T} in transaction T2 is [0.90*88+0.48*22]/[88+22]=0.82. The transaction probability of intermediate classification P(i)_{T} for products P1-P2 in transaction T2 is similar to equation (2) but limited to products P1-P2. From the values in transaction matrix 150, transaction probability P(i)_{T} in transaction T2 is [0.18*88+0.60*22]/[88+22]=0.26. The transaction probability of novice classification P(n)_{T} for products P1-P2 in transaction T2 is similar to equation (3) but limited to products P1-P2. From the values in transaction matrix 150, transaction probability P(n)_{T} in transaction T2 is [0.05*85+0.05*22]/[88+22]=0.05. The transaction weight is transaction price_{P1}+transaction price_{P2}, i.e., 88+22=110.

The transaction probabilities P(e)_{T}=0.82, P(i)_{T}=0.26, and P(n)_{T}=0.05 take into account prior product classification probabilities (P(e)_{P1}, P(i)_{P1}, P(n)_{P1}, P(e)_{P2}, P(i)_{P2}, and P(n)_{P2} from FIGS. 9a-9b) and current transaction price for each product in transaction T2. Each product in transaction T2 from consumer 62 influences the transaction probabilities P(e)_{T}, P(i)_{T}, and P(n)_{T}.

The prior consumer classification probabilities, transaction classification probabilities P(e)_{T}, P(i)_{T}, and P(n)_{T} from transaction T2, and consumer weights specific to consumer 62 are used to update or revise consumer classification probabilities P(e)_{C}, P(i)_{C}, P(n)_{C}. Consumer 62 has conducted prior transactions, e.g., transaction T1, and has accumulated prior consumer classification probabilities P(e)_{C}=0.81, P(i)_{C}=0.35, P(n)_{C}=0.10, and prior consumer weight of 1162, as shown in consumer classification table 152 of FIG. 11. Given transaction probabilities P(e)_{T}=0.82, P(i)_{T}=0.26, and P(n)_{T}=0.05 and transaction prices for transaction T2, the revised consumer classification probabilities P(e)_{C}, P(i)_{C}, P(n)_{C}, and revised consumer weight for consumer 62 are determined according to equations (4)-(6).

From the prior consumer classification probabilities, transaction probabilities P(e)_{T}, P(i)_{T}, and P(n)_{T}, transaction weights, and consumer weights, the revised P(e)_{C} for consumer 62 based on transaction T2 is [0.81*1162+0.82*110]/[1162+110]=0.81. The revised P(i)_{C} for consumer 62 based on transaction T2 is [0.35*1162+0.26*110]/[1162+110]=0.34. The revised P(n)_{C} for consumer 62 based on transaction T2 is [0.10*1162+0.05*110]/[1162+110]=0.10. The revised consumer weight for consumer 62 is the prior consumer weight+transaction weight, i.e., 1162+110=1272. The revised consumer classification probabilities P(e)_{C}, P(i)_{C}, P(n)_{C}, and revised consumer weight specific to consumer 62 for transaction T2 are stored in knowledge base 88 for the next transaction with consumer 62 and products P1-P2, as well as being reported to retailers 66-70 upon request. The revised consumer classification probabilities P(e)_{C}, P(i)_{C}, P(n)_{C} are indicative of the purchasing behavior or pattern of consumer 62 in that he or she is more likely (0.81) to purchase expert classification home tools. Consumer 62 has a lower probability (0.34) of purchasing intermediate classification home tools, as compared to expert classification home tools. Consumer 62 has a lower probability (0.10) of purchasing novice classification home tools, as compared to intermediate classification home tools. The revised consumer weight provides an indication of the total purchasing behavior of consumer 62.

The consumer classification probabilities P(e)_{C}, P(i)_{C}, and P(n)_{C} are used to update or revise product classification probabilities P(e)_{P}, P(i)_{P}, P(n)_{P}, and product weight for each products P1-P2. Given consumer classification probabilities P(e)_{C}=0.81, P(i)_{C}=0.34, and P(n)_{C}=0.10 and transaction prices for transaction T2, the revised product classification probabilities P(e)_{P}, P(i)_{P}, P(n)_{P}, and revised product weights for products P1-P2 are determined accordingly to equations (7)-(9).

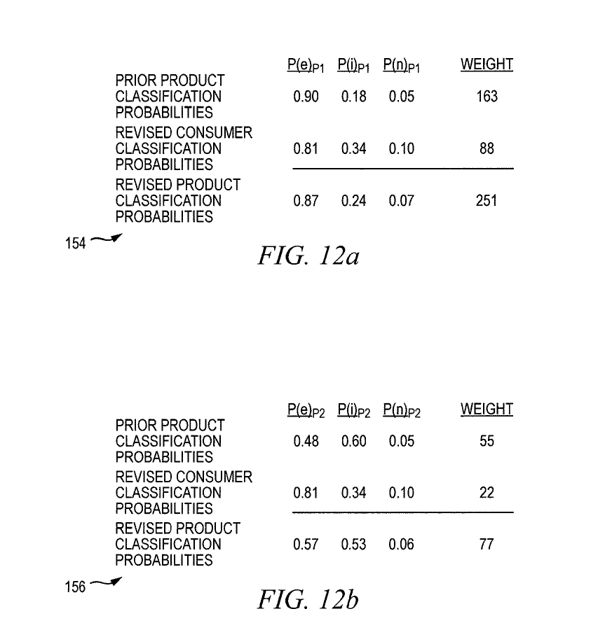

From the values in the prior product classification probabilities P(e)_{P}, P(i)_{P}, and P(n)_{P}, and revised consumer classification probabilities P(e)_{C}, P(i)_{C}, and P(n)_{C}, the revised P(e)_{P1} for product P1 based on transaction T2 is [0.90*163+0.81*88]/[163+88]=0.87, as shown in product classification table 154 of FIG. 12a. The revised P(i)_{P1} for product P1 based on transaction T2 is [0.18*163+0.34*88]/[163+88]=0.24. The revised P(n)_{P1} for product P1 based on transaction T2 is [0.05*163+0.10*88]/[163+88]=0.07. The revised product weight for product P1 is the prior product weight+transaction weight, i.e., 163+88=251.

The revised P(e)_{P2} for product P2 based on transaction T2 is [0.48*55+0.81*22]/[55+22]=0.57, as shown in product classification table 156 of FIG. 12b. The revised P(i)_{P2} for product P2 based on transaction T2 is [0.60*55+0.34*22]/[55+22]=0.53. The revised P(n)_{P2} for product P2 based on transaction T2 is [0.05*55+0.10*22]/[55+22]=0.06. The revised product weight for product P2 is the prior product weight+transaction weight, i.e., 55+22=77.

The revised product classification probabilities P(e)_{P}, P(i)_{P}, P(n)_{P}, and revised product weight for each product P1-P2 in transaction T2 are stored in knowledge base 88 for the next transaction, as well as being reported to retailers 66-70 upon request. The revised product classification probabilities P(e)_{P}, P(i)_{P}, P(n)_{P}, are indicative of the proper product classification for products P1-P2 based on the consumer transactions.

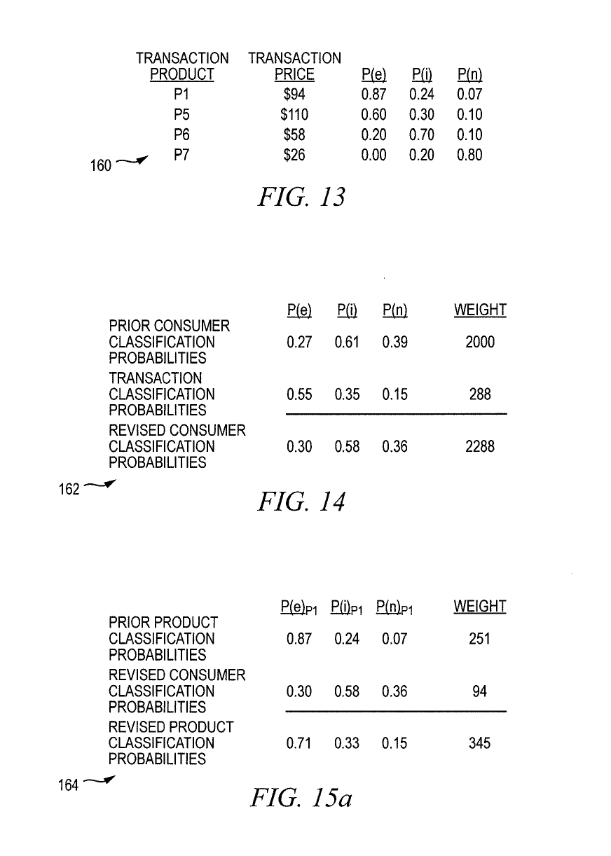

In another example, consumer 64 conducts transaction T3 to purchase products P1, P5, P6, and P7, as shown in FIG. 13. Service provider 80 evaluates consumer transaction T3 and revises knowledge base 88 based on the transaction evaluation. In transaction T3, consumer 64 purchases product P1 for $94, product P5 for $110, product P6 for $58, and product P7 for $26. The revised product probabilities P(e)_{P}, P(i)_{P}, and P(n)_{P} for product P1 are taken from knowledge base 88 and inserted into transaction matrix 160.

The transaction evaluation uses the product probabilities P(e)_{P}, P(i)_{P}, and P(n)_{P} after transaction T2 and transaction prices for products P1 and P5-P7 in transaction T3 to determine weighted transaction probabilities for each product classification, similar to equation (1). Note that the product classification probabilities P(e)_{P1}, P(i)_{P1}, and P(n)_{P1} from FIG. 12a are used for the prior product classification probabilities P(e)_{P}, P(i)_{P}, and P(n)_{P} in transaction T3. From the values in transaction matrix 160, transaction probability for expert classification P(e)_{T} in transaction T3 is [0.87*94+0.60*110+0.20*58+0.00*26]/[94+110+58+26]=0.55. The transaction probability of intermediate classification P(i)_{T} for products P1 and P5-P7 in transaction T3 is similar to equation (2). From the values in transaction matrix 160, transaction probability P(i)_{T} in transaction T3 is [0.24*94+0.30*110+0.70*58+0.20*26]/[94+110+58+26]=0.35. The transaction probability of novice classification P(n)_{T} for P1 and P5-P7 in transaction T3 is similar to equation (3). From the values in transaction matrix 160, transaction probability P(n)_{T} in transaction T3 is [0.07*94+0.10*110+0.10*58+0.80*26]/[94+110+58+26]=0.15. The transaction weight is transaction price_{P1}+transaction price_{P5}+transaction price_{P6}+transaction price_{P7}, i.e., 94+110+58+26=288.

The transaction probabilities P(e)_{T}=0.55, P(i)_{T}=0.35, and P(n)_{T}=0.15 take into account prior product classification probabilities, including P(e)_{P1}, P(i)_{P1}, and P(n)_{P1} from FIG. 12a, and current transaction price for each product in transaction T3. Each product in transaction T3 from consumer 64 influences the transaction probabilities P(e)_{T}, P(i)_{T}, and P(n)_{T}.

The prior consumer classification probabilities, transaction classification probabilities P(e)_{T}, P(i)_{T}, and P(n)_{T} from transaction T3, and consumer weights specific to consumer 64 are used to update or revise consumer classification probabilities P(e)_{C}, P(i)_{C}, P(n)_{C}. If transaction T3 is the first transaction for consumer 64, i.e., no prior transactions, then prior consumer classification probabilities P(e)_{C}=0.00, P(i)_{C}=0.00, P(n)_{C}=0.00, and prior consumer weight is 0. Each transaction by consumer 64 updates or revises the prior consumer classification probabilities P(e)_{C}, P(i)_{C}, P(n)_{C}, and prior consumer weight. Assume consumer 64 has conducted prior transactions and has accumulated prior consumer classification probabilities P(e)_{C}=0.27, P(i)_{C}=0.61, P(n)_{C}=0.39, and prior consumer weight of 2000, as shown in consumer probability table 162 of FIG. 14. Given transaction probabilities P(e)_{T}=0.55, P(i)_{T}=0.35, and P(n)_{T}=0.15 and transaction prices for transaction T3, the revised consumer classification probabilities P(e)_{C}, P(i)_{C}, P(n)_{C}, and revised consumer weight for consumer 64 is determined according to equations (4)-(6).

From the prior consumer classification probabilities, transaction probabilities P(e)_{T}, P(i)_{T}, and P(n)_{T}, transaction weights, and consumer weights, the revised P(e)_{C} for consumer 64 based on transaction T3 is [0.27*2000+0.55*288]/[2000+288]=0.30. The revised P(i)_{C} for consumer 64 based on transaction T3 is [0.61*2000+0.35*288]/[2000+288]=0.58. The revised P(n)_{C} for consumer 64 based on transaction T3 is [0.39*2000+0.15*288]/[2000+288]=0.36]. The revised consumer weight for consumer 64 is the prior consumer weight+transaction weight, i.e., 2000+288=2288. The revised consumer classification probabilities P(e)_{C}, P(i)_{C}, P(n)_{C}, and revised consumer weight specific to consumer 64 for transaction T3 are stored in knowledge base 88 for the next transaction with consumer 64 and products P1 and P5-P7, as well as being reported to retailers 66-70 upon request. The revised consumer classification probabilities P(e)_{C}, P(i)_{C}, P(n)_{C}, are indicative of the purchasing behavior or pattern of consumer 64 in that he or she is less likely (0.30) to purchase expert classification home tools. Consumer 64 has a higher probability (0.58) of purchasing intermediate classification home tools, as compared to expert classification home tools. Consumer 64 has a lower probability (0.36) of purchasing novice classification home tools, as compared to intermediate classification home tools. The revised consumer weight provides an indication of the total purchasing behavior of consumer 64.

The consumer classification probabilities P(e)_{C}, P(i)_{C}, and P(n)_{C} are used to update or revise product classification probabilities P(e)_{P}, P(i)_{P}, P(n)_{P}, and product weight for each product P1 and P5-P7. Given consumer classification probabilities P(e)_{C}=0.30, P(i)_{C}=0.58, and P(n)_{C}=0.36 and transaction prices for transaction T3, the revised product classification probabilities P(e)_{P}, P(i)_{P}, P(n)_{P}, and revised product weights for products P1-P2 are determined accordingly to equations (7)-(9).

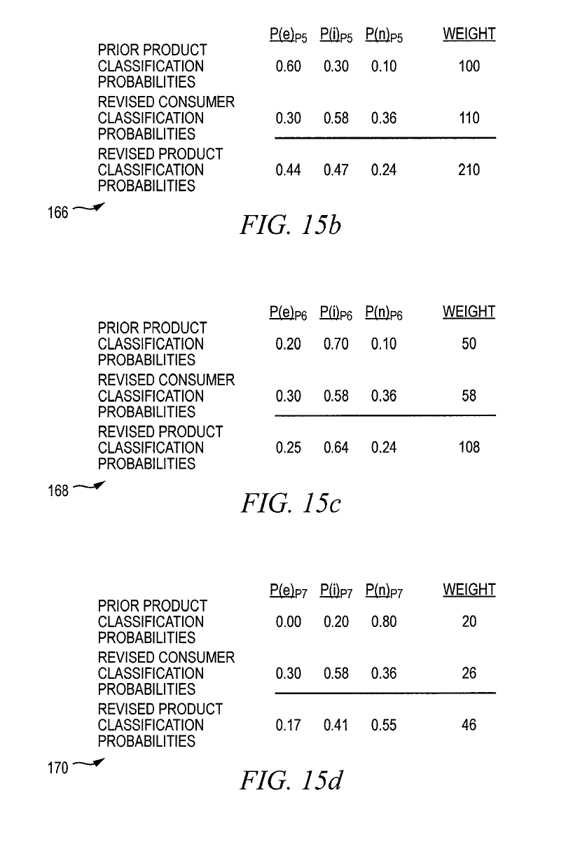

From the values in prior product classification probabilities P(e)_{P}, P(i)_{P}, and P(n)_{P}, and revised consumer classification probabilities P(e)_{C}, P(i)_{C}, and P(n)_{C}, the revised P(e)_{P1} for product P1 based on transaction T3 is [0.87*251+0.30*94]/[251+94]=0.71, as shown in product classification table 164 of FIG. 15a. Note that the product classification probabilities P(e)_{P1}, P(i)_{P1}, and P(n)_{P1} from FIG. 12a are used for the prior product classification probabilities P(e)_{P}, P(i)_{P}, and P(n)_{P} in transaction T3. The revised P(i)_{P1} for product P1 based on transaction T3 is [0.24*251+0.58*94]/[251+94]=0.33. The revised P(n)_{P1} for product P1 based on transaction T3 is [0.07*251+0.36*94]/[251+94]=0.15. The revised product weight for product P1 is the prior product weight+transaction weight, i.e., 251+94=345.

The revised P(e)_{P5} for product P5 based on transaction T3 is [0.60*100+0.30*110]/[100+110]=0.44, as shown in product classification table 166 of FIG. 15b. The revised P(i)_{P5} for product P5 based on transaction T3 is [0.30*100+0.58*110]/[100+110]=0.47. The revised P(n)_{P5} for product P5 based on transaction T3 is [0.10*100+0.36*110]/[100+110]=0.24. The revised product weight for product P5 is the prior product weight+transaction weight, i.e., 100+110=210.

The revised P(e)_{P6} for product P6 based on transaction T3 is [0.60*50+0.30*58]/[50+58]=0.25, as shown in product classification table 168 of FIG. 15c. The revised P(i)_{P6} for product P6 based on transaction T3 is [0.70*50+0.58*58]/[50+58]=0.64. The revised P(n)_{P6} for product P6 based on transaction T3 is [0.10*50+0.36*58]/[50+58]=0.24. The revised product weight for product P6 is the prior product weight+transaction weight, i.e., 50+58=108.

The revised P(e)_{P7} for product P7 based on transaction T3 is [0.00*20+0.30*26]/[20+26]=0.17, as shown in product classification table 170 of FIG. 15d. The revised P(i)_{P7} for product P7 based on transaction T3 is [0.20*20+0.58*26]/[20+26]=0.41. The revised P(n)_{P7} for product P7 based on transaction T3 is [0.80*20+0.36*26]/[20+26]=0.55. The revised product weight for product P5 is the prior product weight+transaction weight, i.e., 20+26=46.

The revised product classification probabilities P(e)_{P}, P(i)_{P}, P(n)_{P}, and revised product weight for each product P1 and P5-P7 in transaction T3 are stored in knowledge base 88 for the next transaction, as well as being reported to retailers 66-70 upon request. The revised product classification probabilities P(e)_{P}, P(i)_{P}, P(n)_{P}, are indicative of the proper product classification for products P1 and P5-P7 based on the consumer transactions.

The product classification probabilities and consumer classification probabilities from knowledge base 88 are made available to retailers 66-70 upon request. The consumer classifications probabilities and product classification probabilities assist the retailer with understanding consumer purchasing behavior and patterns. For example, if consumers regularly purchase products or type of products with specific attributes in a particular store or region, then the retailer can optimize marketing toward that consumer behavior. Retailers can utilize consumer behavior trends from the service provider to conduct targeted advertising and promotion, adjust inventory, and modify product presentation and signage to maximize sales, revenue, and profit.

The product classifications can be based on other attributes of the products. For example, the product attributes for small children items could be based on age group. Product P8 may have a classification of “newborn”, product P9 has a classification of “toddler”, and product P10 has a classification of “preschool.” Alternatively, the product attributes for breakfast cereal could be based on preparation. Product P11 may have a classification of “served cold”, and product P12 has a classification of “served hot.”

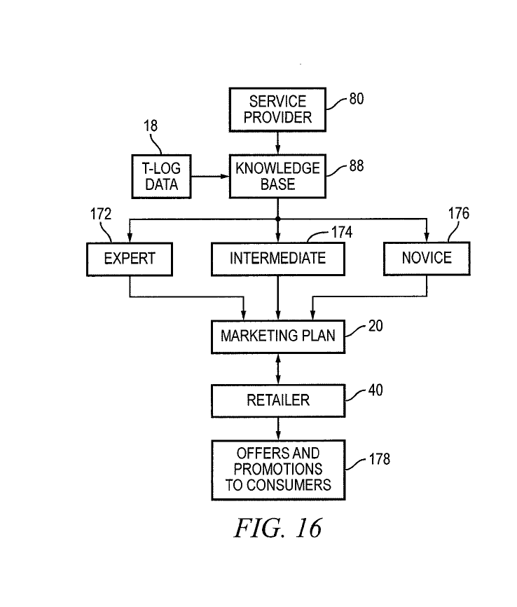

With the analysis of consumer behavior and patterns from T-LOG data 18 as stored in knowledge base 88, service provider 80 can segment or classify consumers 44 into a plurality of groups or segments 172-176, as shown in FIG. 16. Each segment 172-176 has attributes that can be used to optimize marketing plan 20. In the above example, the consumer segmentation includes expert segment 172, intermediate segment 174, and novice segment 176. By segmenting consumers into logical groups, retailer 40 can customize offers and promotions in block 178 for presentation to specific consumers or target segments. For example, one or more consumers in the expert segment would receive offers and promotions for products applicable to experts. Consumers are more likely to make positive purchasing decisions for products they are likely to need and use. The consumer segmentation based on analysis of consumer behavior and patterns increases the effectiveness of marketing plan 20. Consumers are segmented according to the consumer classification probability. In addition, the information in knowledge base 88 assists retailer 50 with business plan 12 in organizing inventory, store layout, seasonality, and consumer service in accordance with shifting consumer preferences, behaviors, and patterns.

The consumer classifications probabilities and product classification probabilities in knowledge base 88 assist retailer 40 with understanding consumer purchasing behavior and patterns. For example, if consumers regularly purchase products or type of products with specific attributes in a particular store or region, then the retailer can optimize marketing toward that consumer behavior. Retailers can utilize consumer behavior trends from the service provider to conduct targeted advertising and promotion, adjust inventory, and modify product presentation and signage to maximize sales, revenue, and profit. The consumer behavior and patterns determined from prior and current transactions allow the retailers to increase consumer transactions within the commerce system.

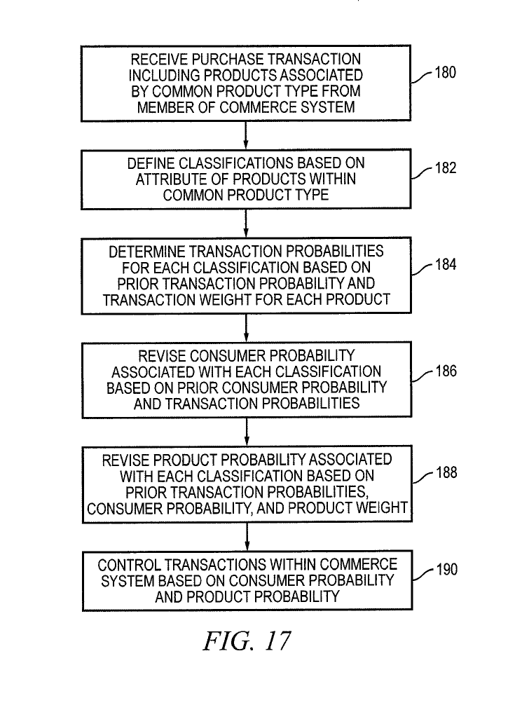

FIG. 17 illustrates a process for controlling a commerce system. In step 180, a purchase transaction is received from a member of the commerce system. The purchase transaction includes products associated by a common product type. In step 182, a plurality of classifications is defined based on an attribute of the products within the common product type. In step 184, a plurality of transaction probabilities is determined for each classification based on a prior transaction probability and transaction weight for each product. The prior transaction probability can be a seed value. The transaction weight includes an accumulation of purchase prices of the product. In step 186, a consumer probability associated with each classification is revised based on a prior consumer probability and the transaction probabilities. The consumer probability indicates a likelihood of a consumer purchasing a product having the attribute associated with the classification. In step 188, a product probability associated with each classification is revised based on a prior transaction probability, consumer probability, and product weight. The product probability indicates a likelihood of a product having the attribute associated with the classification. The product weight includes a purchase price of the product. In step 190, transactions within the commerce system are controlled based on the consumer probability and product probability.

In summary, the service provider in part controls the movement of goods between members of the commerce system. The knowledge base maintained by the service provider contains consumer classification probabilities and product classification probabilities, which are continuously revised based on prior and current transactions. The consumer classifications probabilities and product classification probabilities assist the retailer with understanding consumer purchasing behavior and patterns. For example, if consumers regularly purchase products or type of products with specific attributes in a particular store or region, then the retailer can optimize marketing toward that consumer behavior. Consumers are segmented according to the consumer probability. Retailers can utilize consumer behavior trends from the service provider to conduct targeted advertising and promotion, adjust inventory, and modify product presentation and signage to maximize sales, revenue, and profit. The consumer behavior and patterns determined from prior and current transactions allow the retailers to increase consumer transactions within the commerce system.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
receiving a purchase transaction from a member of the commerce system, the purchase transaction including products associated by a common product type;
defining a plurality of classifications based on an attribute of the products within the common product type;
determining a plurality of transaction probabilities for each classification based on a prior transaction probability and transaction weight for each product;
revising a consumer probability associated with each classification based on a prior consumer probability and the transaction probabilities;
revising a product probability associated with each classification based on a prior transaction probabilities, consumer probability, and product weight; and
controlling transactions within the commerce system based on the consumer probability and product probability.

2. The method of claim 1, wherein the consumer probability indicates a likelihood of a consumer purchasing a product having the attribute associated with the classification.

3. The method of claim 1, wherein the product probability indicates a likelihood of a product having the attribute associated with the classification.

4. The method of claim 1, wherein the transaction weight includes an accumulation of purchase prices of the product.

5. The method of claim 1, wherein the product weight includes a purchase price of the product.

6. The method of claim 1, wherein the prior transaction probability is a seed value.

7. A method of controlling a commerce system, comprising:
providing a purchase transaction including products with a transaction weight;
defining a plurality of classifications based on an attribute of the products;
determining a plurality of transaction probabilities for each classification based on a prior transaction probability and transaction weight for each product;
revising a consumer probability associated with each classification based on a prior consumer probability and the transaction probabilities; and
controlling transactions within the commerce system based on the consumer probability.

8. The method of claim 7, wherein the consumer probability indicates a likelihood of a consumer purchasing a product having the attribute associated with the classification.

9. The method of claim 7, further including revising a product probability associated with each classification based on a prior transaction probability and consumer probability.

10. The method of claim 9, wherein the product probability indicates a likelihood of a product having the attribute associated with the classification.

11. The method of claim 7, wherein the classifications are based on an attribute of the products within the common product type.

12. The method of claim 7, wherein the transaction weight includes an accumulation of purchase prices of the product.

13. The method of claim 7, wherein the prior transaction probability is a seed value.

14. A method of controlling a commerce system, comprising:
providing a purchase transaction including products with a transaction weight;
defining a plurality of classifications based on an attribute of the products;
determining a plurality of transaction probabilities for each classification based on a prior transaction probability and transaction weight for each product;
revising a product probability associated with each classification based on a prior transaction probabilities and consumer probability; and
controlling transactions within the commerce system based on the product probability.

15. The method of claim 14, wherein the product probability indicates a likelihood of a product having the attribute associated with the classification.

16. The method of claim 14, further including revising a consumer probability associated with each classification based on a prior consumer probability and the transaction probabilities.

17. The method of claim 16, wherein the consumer probability indicates a likelihood of a consumer purchasing a product having the attribute associated with the classification.

18. The method of claim 14, wherein the classifications are based on an attribute of the products within the common product type.

19. The method of claim 14, wherein the transaction weight includes an accumulation of purchase prices of the product.

20. The method of claim 14, wherein consumers are segmented according to the consumer probability.

21. A computer program product usable with a programmable computer processor having a computer readable program code embodied in a computer usable medium for controlling a commerce system, comprising:
providing a purchase transaction including products with a transaction weight;
defining a plurality of classifications based on an attribute of the products;
determining a plurality of transaction probabilities for each classification based on a prior transaction probability and transaction weight for each product;
revising a consumer probability associated with each classification based on a prior consumer probability and the transaction probabilities; and
controlling transactions within the commerce system based on the consumer probability.

22. The computer program product of claim 21, wherein the consumer probability indicates a likelihood of a consumer purchasing a product having the attribute associated with the classification.

23. The computer program product of claim 21, further including revising a product probability associated with each classification based on a prior transaction probability and consumer probability.

24. The computer program product of claim 21, wherein the classifications are based on an attribute of the products within the common product type.

25. The computer program product of claim 21, wherein the transaction weight includes an accumulation of purchase prices of the product.
